(19) United States
(12) Patent Application Publication
(10) Pub. No.: US 2007/0114800 A1
(43) Pub. Date: May 24, 2007

(54) Universal door lockset

(76) Inventor: Yung-Chang Kuo, Changhua Hsien (TW)

Correspondence Address: RABIN & BERDO, P.C., Suite 500, 1101 14th Street, N.W., Washington, DC, 20005, US

(21) Appl. No.: 11/266,316

(22) Filed: Nov. 4, 2005

(51) Int. Cl. E05B 15/00

(52) U.S. Cl. 292/244

(57) ABSTRACT

A universal door lockset adaptable to RH or LH mounting configuration and the opening mode by push or pull by adjusting to change the direction of a latch and displacement of a retainer of a deadbolt; latch bolt and latch being screwed to each other; a tool being inserted into a through hole preset at the rear end of a housing for the latch to clear out of a faceplate so to directly turn the latch backward; by turning the latch bolt in opposite direction to force the latch to retreat in locking position, two sets of positioning hole and guide groove being provided to the rear end of the deadbolt to allow insertion of the tool to push the retainer for changing the relation of the deadbolt with an inner and outer retaining units of the deadbolt in conjunction with the 2-in-1 design of rotors.

### BACKGROUND OF THE INVENTION

(a) Field of the Invention

The present invention is related to universal door lockset, and more particularly to a mortise lock designed with a latch that can change its direction to cope with RH or LH door mounting configuration while a retainer of a deadbolt to hold against a handle externally provided to the door allows displacement so to adjust its relation with the door depending on the control configuration of door opening thus to achieve excellent industrial value and practical use for a single lockset to meet various mounting requirements.

(b) Description of the Prior Art

In the design of the construction of a lockset, a row of toggle mechanism is provided. To open the door, a key way is designed in conjunction with the row of toggle mechanism. The key inserted into the key way turns to control the row of toggle mechanism to retreat by stage until reaching the last stage to drive toggle arm connected to the toggle mechanism to move the latch bolt or the door opening is controlled by a door handle present to cause the deadbolt to retreat in thus to clear out of the locking aperture disposed in the door frame.

Generally, a door plank depending on its direction assembly and the opening configuration is assembled for opening to its LH or RH, and push or pull. The type of the door lockset also varies depending on the assembly of the door plank and the opening type. The most significant differences among locksets rest on the direction of the latch and the position of the retainer of the deadbolt. Accordingly, many different types of locksets must be designed for the conventional door locksets to compromise the individual assembly type of the door plank resulting in increased production costs and inventory problem to the lockset manufacturers and risk of buying wrong type of locket to the consumer.

Improvement has been done by having a universal design for the members of the door lockset so that the retainer of the deadbolt allow assembly at a position and in a direction for the assembly of a door lockset depending on the requirements of the assembly of the door lockset. The improvement saves the efforts for the manufacturers in design door locksets of many types and specifications. They only have to make adjustment and changes among the existing parts depending on the type of lockset as ordered so to prevent significant increase of the general production cost to meet the required economic benefits in the trade.

However, the improvement of allowing adjustment and change in the design of parts and components of the door lockset solves the problems of facing higher production cost due to availability of many specifications. It is not necessarily good news for the consumer. The reason is that once the latch and the retainer of the deadbolt have been given a specific direction and they when assembled are prevented from making any adjustment in the direction and position. Therefore, the risk of buying the wrong type of lockset to the consumer has not yet solved since the consumer has to select the door lock depending on the configuration of the door plank. The consumer's risk justifies a further improvement of the door lockset of the prior art.

### SUMMARY OF THE INVENTION

The primary purpose of the present invention is to provide a construction of a universal door lockset that meets the installation requirements of any type of door lockset whether the door lockset is of LH or RH installation configuration or a push or pull type by allowing adjustment and change of the displacement of a deadbolt retainer.

Another purpose of the present invention is to provide a construction of a universal door lockset that allows the consumer to adjust the displacement of the deadbolt retainer and the direction of the latch before mounting the lockset to the door to eliminate the risk of buying the wrong type of door lockset.

To achieve the purpose, the latch and a latch bolt are screwed to each other so to allow insertion by a long tool from a through hole disposed at the top of the rear end of a housing of the lockset to control the latch by turning it. Accordingly, changing the direction of the latch both is done by having the latch with its rear end being limited has its front end to clear out of a faceplate to direct turn the latch into another direction, and then the latch bolt turned in opposite direction to force it retreating back to restore both of the latch and the latch bolt into their locking relation in coping with LH or RH mounting configuration. Furthermore, in the design of the deadbolt retainer to restrict the retain the rotor of a door handle, two sets of a positioning hole and a guide groove are disposed to the rear end of the deadbolt so to allow insertion of a tool to push and move the retainer for altering the relation between the deadbolt and inner or the outer retaining units of the lockset in conjunction with two rotors of the handle arranged in parallel with each other. Therefore, the performance of the control by the handle is determined by changing the retaining relation between the retainer and an inner or an outer rotor of the door handle to cope with the manipulation configuration of opening the door by push or by pull. Accordingly, the present invention by providing a single lockset that is adaptable to various installation requirements among different types of door lockset to permit adjustment of the direction of the latch in coordination with the adjustment of the position of the deadbolt retainer achieves excellent industrial value and practical use.

### BRIEF DESCRIPTION OF THE DRAWINGS

FIG. 1 is a schematic view showing a general construction of a preferred embodiment of the present invention.

FIG. 2 is an exploded view showing a partial construction of the preferred embodiment of the present invention.

FIG. 3 is an exploded view of a latch and a latch bolt of the preferred embodiment of the present invention taken from FIG. 2.

FIG. 4 is an exploded view of a deadlock of the preferred embodiment of the present invention taken from FIG. 2.

FIG. 5 is a first schematic view showing constructional relation in adjustment and change of the direction of the latch of the preferred embodiment of the present invention.

FIG. 6 is second schematic view showing constructional relation in adjustment and change of the direction of the latch of the preferred embodiment of the present invention.

FIG. 7 is third schematic view showing constructional relation in adjustment and change of the direction of the latch of the preferred embodiment of the present invention.

FIG. 8 is a fourth schematic view showing constructional relation in adjustment and change of the direction of the latch of the preferred embodiment of the present invention.

FIG. 9 is a schematic view showing constructional relation of a status when a retainer is not restricting a rotor of the preferred embodiment of the present invention.

FIG. 10 is a schematic view showing constructional relation of a status when the retainer is restricting the rotor of the preferred embodiment of the present invention.

FIG. 11 is a schematic view showing constructional relation between the deadbolt and the retainer of the preferred embodiment of the present invention.

FIG. 12 is a schematic view showing constructional relation of adjustment of relative positions between the deadbolt and the retainer of the preferred embodiment of the present invention.

FIG. 13 is another schematic view showing constructional relation of adjustment of relative positions between the deadbolt and the retainer of the preferred embodiment of the present invention.

### DETAILED DESCRIPTION OF THE PREFERRED EMBODIMENTS

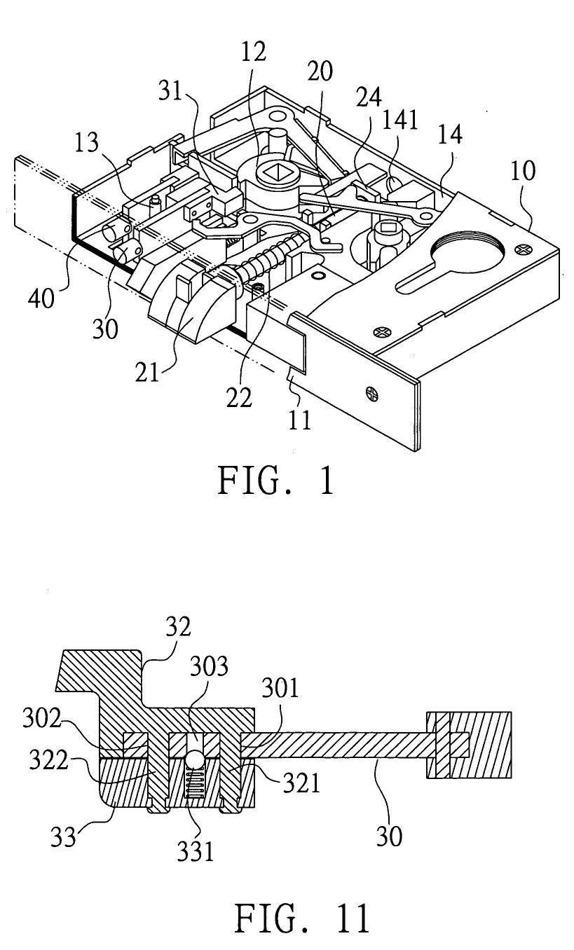

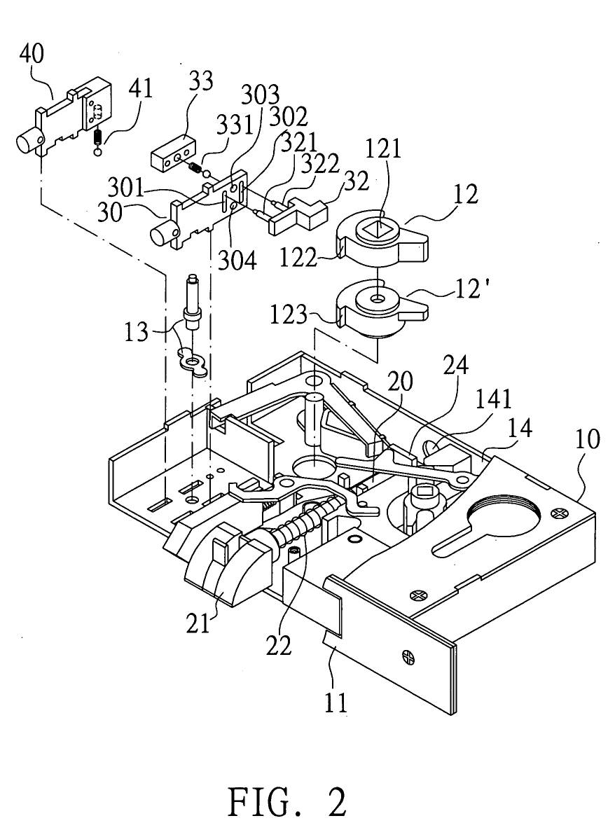

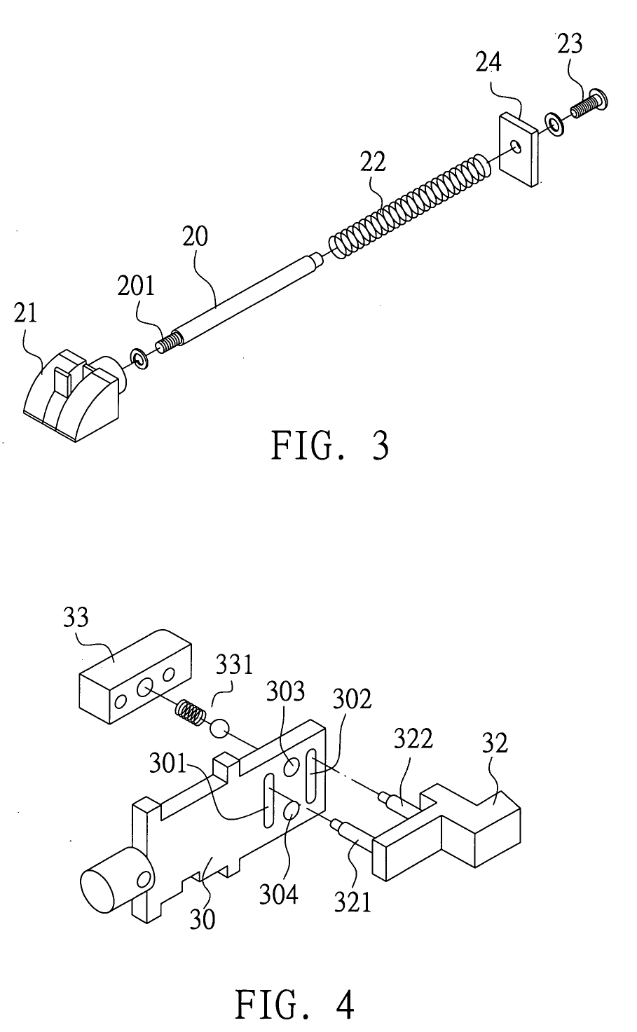

Referring to FIGS. 1 through 4 for a preferred embodiment of the present invention, it is to be noted first that the improvement made by the present invention is essentially on a latch and a deadbolt to limit a rotor of a door handle and for the other members are of the prior art and that no description will be repeated for those members. A universal door lockset is essentially comprised of a housing (10) to accommodate a row of toggle mechanism (not illustrated) and related mechanical parts. A latch bolt (20) is disposed in the middle of the housing (10) and a latch (21) is connected to the tip of the latch bolt (20). The latch (21) passes through an aperture preset on a faceplate (11) of the housing (10) so to be restricted by an aperture from a doorframe (not illustrated). Two rotors 12, 12′ subject to manipulation by a handle (not illustrated) disposed below the housing (10) operate to retreat the latch bolt (20) in conjunction with a toggle lever and linkage thus to allow the latch (21) to retreat and clear from the restriction by the aperture in the doorframe and open up the door. A deadbolt (30) and a release member (40) are disposed beneath the housing (10). Both of the deadbolt (30) and the release member (40) arranged in parallel with each other rotate to control alterative expansion between the deadbolt (30) and the release member (40) through a toggle assembly (13) disposed at where between the deadbolt (30) and the release member (40). A retainer (31) is further disposed at the inner end of the deadbolt (30) to restrict the deadbolt (30) in relation to both rotors (12, 12′) when the deadbolt (30) retreats to disable the door handle in manipulating the latch bolt (20) for anti-burglar purpose. Wherein, a threaded section (201) is provided at the front end of the latch bolt (20) so to be fastened by means of a nut to the latch (21). A spring (22) is inserted onto the latch bolt (20) to provide return function to the latch bolt (20). A bolting hole (not illustrated) is disposed at the rear end of the latch bolt (20) for a rectangular locking piece (24) to be locked to the rear end of the latch bolt (20) by means of a bolt (23). Upon being locked in, the bolt (23) is coated with adhesive so to be fixed to the latch bolt (20) for constituting linkage between the bolt (23) and the latch bolt (20). When a tool is used to turn and control the bolt (23), the latch bolt (20) is turned without moving to relatively push outward the latch (21) to facilitate the latch (21) to shift in direction while a limiting plate (24) is subject to the manipulation of both rotors (12, 12′) from the door handle (not illustrated).

The deadbolt (30) is provided at its rear end a front and a rear longitudinal guide grooves (301, 302) and an upper and lower positioning holes (303, 304). Meanwhile, a retainer (31) comprised by insertion of a locking member (32) and a base member (33) is disposed at the rear end of the deadbolt (30). Two pins (321, 322) are provided to the locking member (32) pass through those two guide grooves (301, 302) on the deadbolt (30) to engage with the base member (33) for becoming an integral part. A single steel ball spring (331) is disposed to the base member (33) at where in relation with the positioning holes (303, 304) of the deadbolt (30) so to allow the retainer (31) execute longitudinal displacement and hold the longitudinal relation between the retainer (31) and the deadbolt (30) with the steel ball spring (331). Accordingly in conjunction with the two-in-one design of the rotor (12) of the handle, the deadbolt (30) achieves its control by turning depending on whether the inner or the outer rotor (12, 12′) to be restricted as selected by adjusting the longitudinal retainer (31).

A set of steel ball spring (41) is embedded at the bottom edge of the rear end of the release member (40) to determine the front or the rear position of the release member (40) in conjunction with both positioning holes (101, 102) preset on the housing (10).

Both rotors (12, 12′) are made in a 2-in-1 fashion and each is provided with an independent insertion hole (121) to be linked to the handle of the door (not illustrated) for an inner and an outer door handle to respectively control their rotors (12, 12′) by turning, thus to force both of the latch bolt (20) and the latch (21) to retreat for opening the door. Two retaining gradations (122, 123) are respectively provided to the side edges of both rotors (12, 12′) by compromising the longitudinal positions of the retainer (31) of the deadbolt (30) to decide which retaining gradations (122, 123) of their corresponding rotors (12, 12′) to be restricted to disable the handle of the door.

By taking advantage of the direction shift design of the latch (21) of the latch bolt (20), the lockset of the present invention is capable of coping with LH or RH mounting requirements. Meanwhile, by adjusting the longitudinal position of the retainer (31) of the deadbolt (30), the selection of the rotor 12 or 12′ to perform the restriction is made so to adjust the relative position of the retainer (31) to cope with the opening mode of the door by pushing or pulling it.

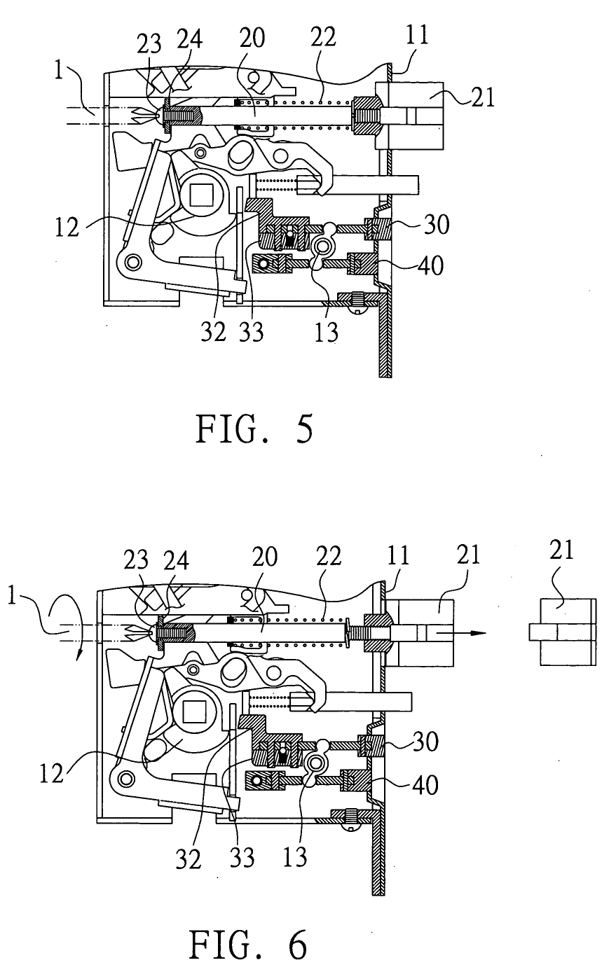

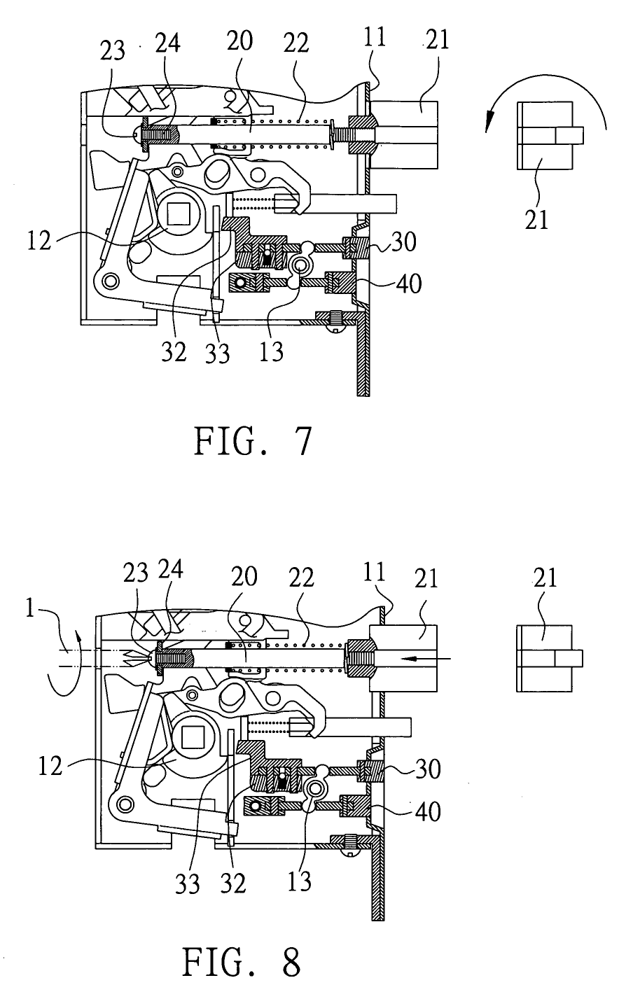

Now referring to FIGS. 5˜8 for the direction shift adjustment of the latch (21) of the latch bolt (20), a through hole (141) is provided on a rear plate (14) of the housing (10) at where in relation to the latch bolt (20) to allow the insertion by a tool (1), e.g., a screwdriver, to engage the bolt (23) disposed to the rear end of the latch bolt (20) so to link with the latch bolt (20) for the tool (1) to manipulate the turning of the latch bolt (20). Whereas the limiting plate (24) at the rear end of the latch bolt (20) is restricted by the toggle arm and linkage of both rotors (12, 12′) of the handle (not illustrated), the latch bolt (20) is turning without moving. Meanwhile the latch (21) at the front end of the latch bolt (20) is restricted in an aperture of the faceplate (11) of the housing (20). The turning latch bolt (20) without moving causes its latch (21) to relatively move outward until it is completely cleared out of the aperture of the faceplate (11) to directly turn the latch (21) and the latch bolt (20) for 180 degrees. The tool (1) turns the latch bolt (20) in opposite direction for the latch (21) to once again engage and retreat with the latch bolt (20) to restore to the original configuration of the limiting relation between the latch (21) and the notch of the faceplate (11) of the housing (10) to complete the adjustment of the direction of the latch (21) to cope with whether the lockset will be mounted on a door plank that is pushed or pulled to open.

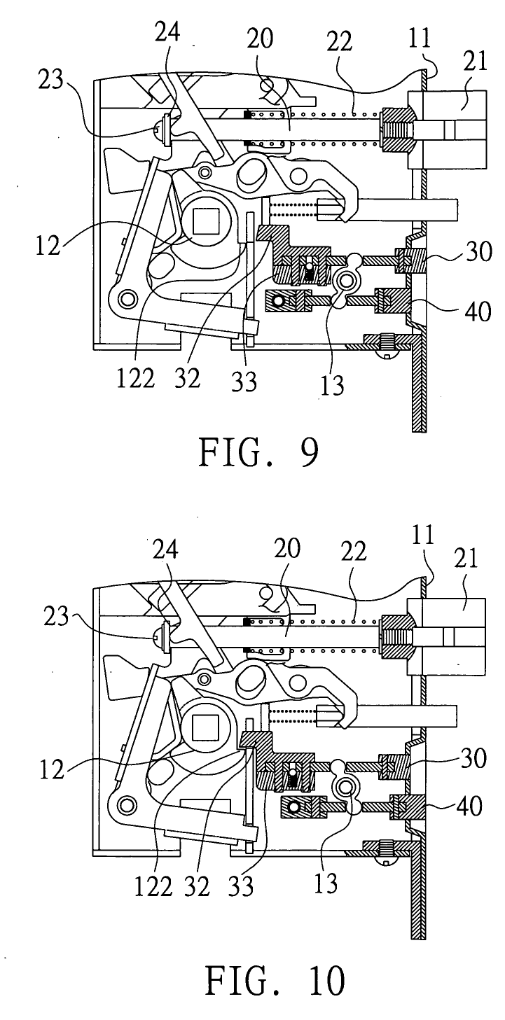

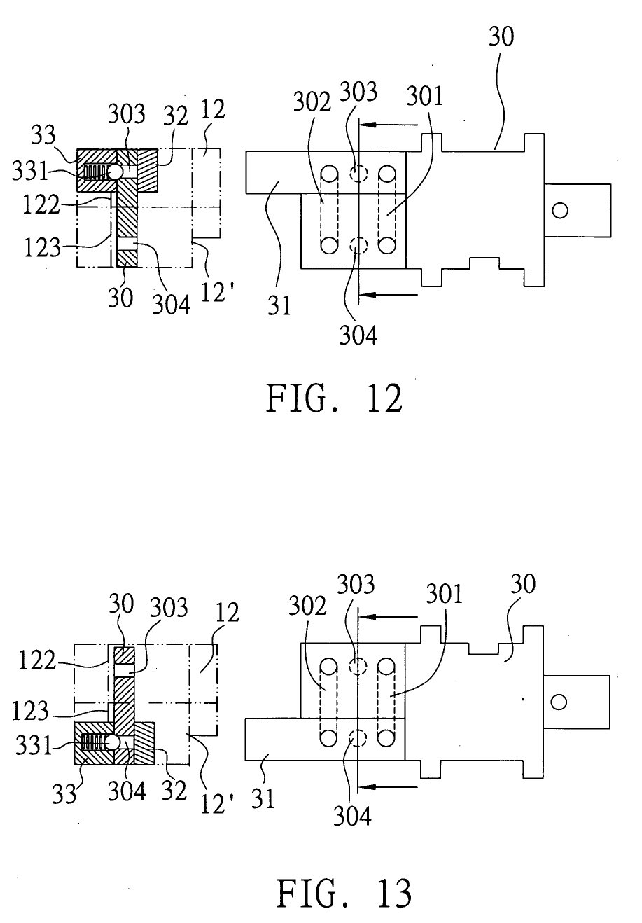

As illustrated in FIGS. 9˜13 for the relation of the position adjustment of the retainer (31) of the deadbolt (30) to both rotors (12, 12′), the performance of adjusting the longitudinal position of the retainer (31) and the deadbolt (30) is enabled by the coordination between both guide grooves (301, 302) and both pins (321, 322). Therefore, a shank from a tool inserted into through holes respectively preset on an upper faceplate and a lower faceplate on the housing (10) pushes the retainer (31) to change its relation with the deadbolt (30). The retainer (31) is restricted in place by the steel ball spring (331) in the retainer (31) and either of the upper or the lower positioning hole (303, 304) of the deadbolt so to maintain the relative positions between the retainer (31) and the deadbolt (30). When the retainer (31) is located at where below the deadbolt (30), it restricts the retaining gradation (123) of the lower rotor (12′) to prevent the lower rotor (12′) from tuning thus to prevent the handle connected to the retainer (31) from manipulating the linked latch bolt (20) and the latch (21) to retreat. Meanwhile, the other rotor (12) is free from the restriction, so that the function to retreat of the latch bolt (20) and its latch (21) is not affected. On the contrary, if the retainer (31) is located at where above the deadbolt (30), the retaining gradation (122) of the upper rotor (12) is restricted thus to lose it function to control the latch bolt (20) and its latch (21) to retreat while the function of the lower rotor (12′) is not affected. Accordingly, the lockset of the present invention is ideally for compromising the assembly position and the LH or RH assembly configuration by allowing the insertion of a tool to directly push to move the position of the retainer (31) without removing the housing (10). Under the condition that the deadbolt (30) is pressed into a preset locked status, the rotor (12) or (12′) of the handle disposed outside the door plank to prevent the handle to operate the latch bolt (20) and its latch (21) to retreat for achieving burglar proof results.

The door lockset of the present invention provides reasonable adjustment function to the direction of the latch of the latch bolt and the position of the retainer of the deadbolt for compromising the type and location of the assembly of the lockset and even the mounting and opening directions of the door simply by insertion of a proper tool to change the direction of the latch and the position of the retainer for the door lockset to comply with field mounting and operation requirements. The removal of the housing of the lockset is not required during the adjustment. The adjustment does not call for professional skill to make the adjustment and can be easily done by a consumer. The present invention provides a universal door lockset answering the mounting requirements of various types of door locksets with easy adjustment to give the present invention excellent industrial value and utility.

To sum up, the construction of the universal door lockset of the present invention for coping with the RH or LH mounting configuration and the door opening mode of push or pull by adjusting to change the direction of the latch and the displacement of the retainer of the deadbolt to allow a single lockset to meet the mounting requirements of various types of door locksets with an easy adjustment provides excellent industrial value and utility, therefore, this application is duly filed.

1. A universal door lockset is essentially comprised of a housing to accommodate a row of toggle mechanism and related mechanical parts; a latch bolt being disposed in the middle of the housing and a latch being connected to the tip of the latch bolt; the latch passing through an aperture preset on a faceplate of the housing so to be restricted by a aperture from a doorframe; two rotors subject to manipulation by a handle disposed below the housing operating to retreat the latch bolt in conjunction with a toggle lever and linkage thus to allow the latch to retreat and clear from the restriction by the aperture in the doorframe and open up the door; a deadbolt and a release member being disposed beneath the housing; both of the deadbolt and the release member being arranged in parallel with each other rotate to control alterative expansion between the deadbolt and the release member through a toggle assembly disposed at where between the deadbolt and the release member; and a retainer being further disposed at the inner end of the deadbolt to restrict the deadbolt in relation to both rotors when the deadbolt retreats to disable the door handle in manipulating the latch bolt for burglarproof purpose is characterized in that:
a threaded section being provided at the front end of the latch bolt so to be fastened by means of a nut to the latch; a spring being inserted onto the latch bolt to provide return function to the latch bolt; a bolting hole being disposed at the rear end of the latch bolt for a rectangular locking piece to be locked to the rear end of the latch bolt by means of a bolt; the bolt being coated with adhesive so to be fixed to the latch bolt for constituting linkage between the bolt and the latch bolt; a tool being used to turn and control the bolt, the latch bolt being turned without moving to relatively push outward the latch to facilitate the latch to shift in direction; and a limiting plate being subject to the manipulation of both rotors from the door handle;

2. A universal door lockset is essentially comprised of a housing to accommodate a row of toggle mechanism and related mechanical parts; a latch bolt being disposed in the middle of the housing and a latch being connected to the tip of the latch bolt; the latch passing through an aperture preset on a faceplate of the housing so to be restricted by a aperture from a doorframe; two rotors subject to manipulation by a handle disposed below the housing operating to retreat the latch bolt in conjunction with a toggle lever and linkage thus to allow the latch to retreat and clear from the restriction by the aperture in the doorframe and open up the door; a deadbolt and a release member being disposed beneath the housing; both of the deadbolt and the release member being arranged in parallel with each other rotate to control alterative expansion between the deadbolt and the release member through a toggle assembly disposed at where between the deadbolt and the release member; and a retainer being further disposed at the inner end of the deadbolt to restrict the deadbolt in relation to both rotors when the deadbolt retreats to disable the door handle in manipulating the latch bolt for burglarproof purpose is characterized in that:
the deadbolt being provided at its rear end a front and a rear longitudinal guide grooves, an upper and lower positioning holes; a retainer comprised by insertion of a locking member and a base member being disposed at the rear end of the deadbolt; two pins provided to the locking member passing through those two guide grooves on the deadbolt to engage with the base member for becoming an integral part; a single steel ball spring being disposed to the base member at where in relation with the positioning holes of the deadbolt so to allow the retainer executing longitudinal displacement and hold the longitudinal relation between the retainer and the deadbolt with the steel ball spring; in conjunction with the two-in-one design of the rotor of the handle, the deadbolt achieving its control by turning depending on whether the inner or the outer rotor to be restricted as selected by adjusting the longitudinal retainer.

3. The universal lockset of claim 1, wherein a through hole is provided on a rear plate of the housing at where in relation to the latch bolt to allow the insertion by a tool to engage the bolt disposed to the rear end of the latch bolt so to link with the latch bolt for the tool to manipulate the turning of the latch to change direction without the necessity to remove the housing of the lockset.

4. The universal lockset of claim 2, wherein through holes are provided on the housing at where in relation to the upper and the lower faceplates of the retainer disposed at the rear end of the deadbolt to change the relative positions between the retainer and the deadbolt by inserting a tool.
